(19) United States
(12) Patent Application Publication
(10) Pub. No.: US 2008/0019318 A1
(43) Pub. Date: Jan. 24, 2008

(54) Cryptographic Optimisation for Duplicate Address Detection

(76) Inventors: Ammad Akram, Tilehurst (GB); Nikolaos Prelorentzos, Athens (GR)

Correspondence Address: RATNERPRESTIA, P.O. BOX 980, VALLEY FORGE, PA, 19482, US

(21) Appl. No.: 11/587,259

(22) PCT Filed: Apr. 1, 2005
(86) PCT No.: PCT/GB05/01302

§ 371 Date: Aug. 8, 2007

(30) Foreign Application Priority Data
Apr. 23, 2004 (GB) 0409132.8

(51) Int. Cl. H04Q 7/24

(52) U.S. Cl. 370/331

(57) ABSTRACT

Cryptographic Optimisation for Duplicate Address Detection Cryptographic Optimisation for Duplicate Address Detection is achieved by providing access routers with the cryptographic key and auxiliary parameters such that the access routers can generate CGA addresses on behalf of the MN and return these CGA addresses to the MN.

This invention relates to mobile communications and in particular it relates to methods for making Duplicate Address Detection (DAD) compatible with both Cryptographically Generated Addresses (CGA) and the Fast Mobile Internet Protocol (FMIP).

### INTRODUCTION

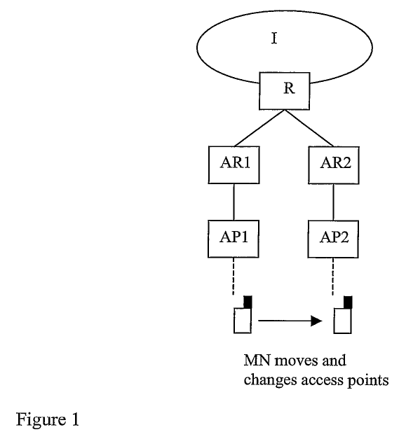

FIG. 1 shows a standard Mobile IPv4 [1], Mobile IPv6 [2] and FMIP [3] configuration for enabling mobile communications between a Mobile Node (MN), such as a portable telephone, and a Corresponding Node (CN), not shown, via the Internet I. The Mobile Node MN is wirelessly connected to the network via the access point AP1 initially and subsequently via AP2 and the access routers AR1 and AR2 are connected to the Internet via a Router R.

Upon connection to AP2, the MIPv4/v6 protocols require the MN to obtain a new Care Of Address (nCoA) that is subsequently registered with the Home Agent (HA) and for MIPv6, additionally, also the CN. Upon completion of these so-called binding update (BU) operations, the MN is able to receive data packets via AR2. For real-time applications in particular, the BU latency for MIPv4/v6 may prove too great to maintain a desired quality of service. In such instances, FMIP can be used to obtain lower BU latency. The FMIP protocol broadly allows the MN to send packets as soon as it detects AR2 and for packets to be delivered to the MN as soon as AR2 detects the presence of the MN.

Regardless of whether MIP or FMIP is being used to complete the handover between AR1 and AR2, an IPv6 CoA can be obtained through stateful or stateless address configuration. The present invention focuses on the stateless case where the uniqueness of the generated CoA needs to be verified using the Duplicate Address Detection (DAD) protocol. IPv6 prohibits the assignment of a new IP address to a physical MN interface, whether for MIP or any other purpose, before that address has been proven to be unique on the link using DAD.

Stateless address configuration enables a host to generate its own address using a combination of locally available information and information advertised by access routers. Access routers advertise prefixes that identify the subnet(s) associated with a link, while nodes generate a link local address that uniquely identifies an interface on a subnet. A globally routable address is formed by combining the link local address and subnet prefix after the link local address has been proven to be unique, i.e., not already in use by another node on the link.

The conventional DAD protocol [4] requires the MN to inform its neighbours of the tentative link local address it intends to take up and wait for replies from any node already using that address. There is a random initial delay between 0-1 seconds before the MN can inform its neighbours and then there is an additional delay of around 1 second that the MN waits for replies from neighbours. Such delays in communicating with neighbours interrupt any ongoing sessions that the MN wishes to transfer between AP1 and AP2. The resulting data loss makes conventional DAD particularly unsuitable for real-time applications.

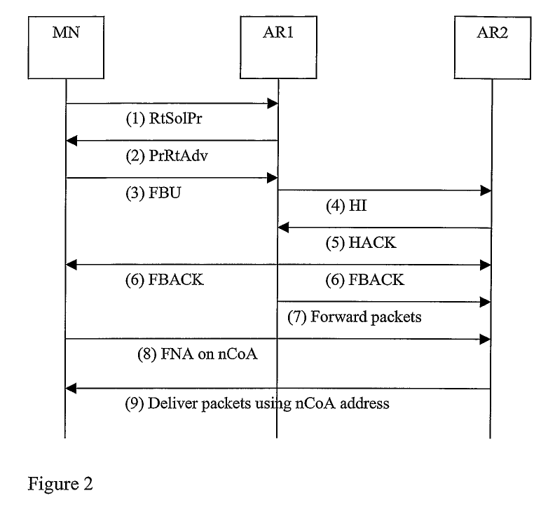

FIG. 2 illustrates the standard signal flow diagram for completing a FMIP predictive mode handover between two ARs whilst utilising DAD. Each step is now described in detail.

Step 1—the MN sends the Router Solicitation for Proxy (RtSolPr) to AR1 requesting information for the impending handover.

Step 2—AR1 sends back the Proxy Router Advertisement (PrRtAdv) message to MN that contains information such as prefixes for AR2 enabling the MN to formulate the nCoA.

Step 3—the Fast Binding Update (FBU) message containing the prospective nCoA is sent from the MN to notify AR1 that it is about to change to AR2.

Step 4—this readiness by the MN to change ARs is relayed by AR1 to AR2 within the Handover Initiation (HI) message.

Step 5—AR2 acknowledges readiness to receive MN within the Handover Acknowledgement (HACK) message and confirms whether nCoA has been determined to be unique on the new link, if necessary returning an alternative nCoA that MN must then use.

Step 6—AR1 sends Fast Binding Acknowledgement (FBACK) to both MN and AR2. Arrival of FBACK at AR2 is the trigger for packets to be tunnelled between AR1 and AR2 and subsequently buffered at AR2 (step 7).

Step 7 separates the predictive and reactive modes of FMIP. In the predictive mode, FBACK is received by the MN via AR1 indicating that packet tunnelling will already be in progress between AR1 and AR2 when the MN arrives on the new link. In the reactive mode, the MN does not receive FBACK via AR1 perhaps because it did not send an FBU on account of leaving the old link too quickly (step 3) or that the FBU was somehow lost. Therefore in the reactive mode, the MN has to issue the FBU after arriving on the new link to start packet tunnelling between AR1 and AR2.

Step 8—the MN issues a Fast Neighbour Advertisement (FNA) to AR2 to announce that it will be using the nCoA address on the new network.

Step 9—the FNA is the trigger for AR2 to commence delivery of buffered packets to MN nCoA address.

From FIG. 2, it will be noted that it is the role of AR2 to verify that nCoA contained in the HI is a valid address, i.e., ensure that nCoA is unique on new network. Clearance to use the proposed nCoA is reported back to AR1 on the HACK (5) and subsequently to the MN on the FBACK (6).

A limitation is seen with providing an alternative nCoA from AR2 on the HACK message in the case where the MN has used Cryptographically Generated Addresses (CGA). With CGA, a node uses a key in its possession to generate a link local address for itself [5]. CGA has been developed as a technique to prevent identity spoofing of a node taking part in neighbourhood discovery message exchanges. A particular threat is the re-direction attack whereby a malicious node spoofs the identity of a legitimate node and requests the last hop router to re-direct data intended for the node to another interface.

The present invention seeks to overcome the limitation that AR2 is unable to generate an alternative CGA nCoA for the MN unless it is provided with additional information such as the cryptographic key used by the MN.

Thus the invention provides a method as described in claim 1.

Preferred features of the invention are described in the subsidiary claims.

An example of the invention will now be described showing compatibility with the predictive mode of the FMIP protocol with reference to the accompanying drawings in which like parts are designated like reference numerals and in which:

FIG. 1 schematically illustrates a MN with an ongoing session with a CN (not shown) in the process of handing over between AP1 and AP2.

FIG. 2 shows the signal flow diagram for the FMIP predictive mode.

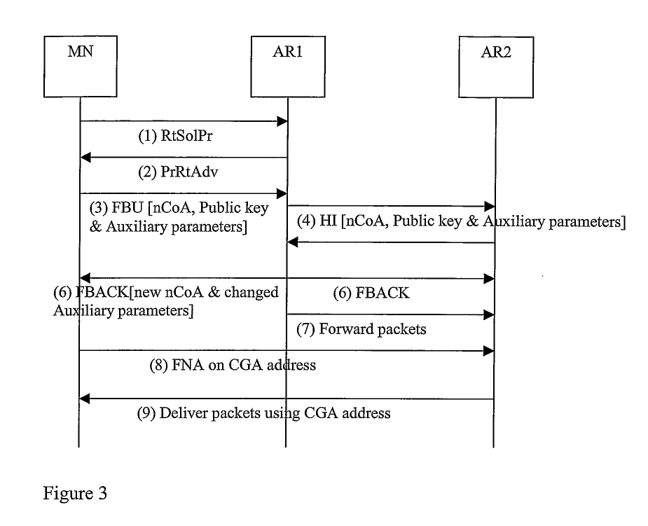

FIG. 3 illustrates the signal flow diagram for the FMIP predictive mode where the AR2 is provided the information to enable it to generate a CGA address for the MN.

FIG. 3 outlines a proposed signal flow diagram to cover the case where the AR2 discovers that nCoA is invalid on the new network. In the event of an address conflict, AR2 could return an alternative nCoA that the MN will be forced to use. However, the alternative nCoA will not be a CGA compatible address unless it has been generated with the cryptographic key of the MN. The MN in this situation could generate and propose another CGA nCoA but the additional signalling latency for AR2 to verify secondary addresses would significantly negate the advantages of FMIP to complete a fast handover.

The present invention proposes that the MN additionally provides the public cryptographic key and the various auxiliary parameters used to generate the CGA nCoA to AR2 in the HI message. If AR2 finds the proposed nCoA to be non-unique on the new link, another nCoA is CGA generated using the same public key with changed auxiliary parameters. The significant differences between FIGS. 2 and 3 are:

Step 3—FBU contains proposed CGA nCoA and additionally the public cryptographic key and auxiliary parameters used to generate nCoA. The FBU will also contain information indicating the range over which the auxiliary parameters can be changed by AR2.

Step 4—the public cryptographic key and auxiliary parameters are relayed to AR2 on the HI.

Step 5—the HACK either contains the proposed verified nCoA or, if that nCOA was found non-unique, a new nCoA along with the modified auxiliary parameters used to generate the new nCoA.

Step 6—the changed nCoA and associated auxiliary parameters are relayed to the MN via the FBACK.

In a further possible method according to the invention, the MN provides a list of secondary CGA nCoA addresses to be used if a main CoA is not acceptable. The flowchart would be similar to FIG. 5 with the following differences:

Step 3—the MN provides with the FBU a list of secondary CGA nCoA addresses that are invoked if the main nCoA is found to be non-unique. No public key or auxiliary parameters need to be passed to AR2 in this method.

Step 4—the HI contains the list of secondary CGA nCoA addresses.

Step 5—the HACK contains the index of the CGA nCoA that has been cleared by AR2.

Step 6—the FBACK contains the index of the CGA nCoA that has been cleared by AR2.

### REFERENCES

[1] RFC3344, IP Mobility Support for IPv4 http://www.ietf.org/rfc/rfc3344.txt?number-3344
[2] Draft-ietf-mobileip-ipv6-24.txt, Mobility Support in IPv6 http://www.ietf.org/internet-drafts/draft-ietf-mobileip-ipv6-24.txt
[3] Draft-ietf-mobileip-fast-mipv6-08.txt, Fast Handovers for Mobile IPv6 http://www.ietf.org/internet-drafts/draft-ietf-mobileip-fast-mipv6-08.txt
[4] RFC2461, Neighbour Discovery for IP Version 6 (IPv6) http://www.ietf.org/rfc/rfc2461.txt?number=2461
[5] P. Nikander, Denial-of-Service, Address Ownership, and Early Authentication in the IPv6 World, Cambridge Security Protocols Workshop 2001, Apr. 25-27, 2001

1. A method of managing the handover of a mobile node (MN) from a first communications node to a second communications node using cryptographically generated addresses in which a message including a proposed cryptographically generated new care-of address (CGAnCoA) for the mobile node is issued by the mobile node accompanied by information to enable a different CGAnCoA to be used by the node to which the message is sent if the proposed CGAnCoA is not acceptable.

2. A method as claimed in claim 1 in which the accompanying information includes the cryptographic key of the MN used to generate the CGAnCoA and the communications node to which the message is sent generates the different CGAnCoA using the cryptographic key.

3. A method as claimed in claim 2 in which the accompanying information includes auxiliary parameters used to generate the CGAnCoA.

4. A method as claimed in claim 1, in which the CGAnCoA is proposed by the MN and included with the accompanying information in the message used by the MN to inform the first communications node of its impending intention to change to the second communications node.

5. A method as claimed in claim 4 in which the message is the Fast Binding Update (FBU) message in the case of FMIP.

6. A Method as claimed in claim 1 in which the additional information is carried in a message between the first and second communications nodes indicating the readiness of the MN to change communications nodes.

7. A method as claimed in claim 6 in which the message is the Handover Initiation (HI) message in the case of FMIP.

8. A method as claimed in claim 1 in which an acceptable nCoA and additional information is carried in a message between the first and second communications nodes indicating the readiness of the second communications node to receive the MN.

9. A method as claimed in claim 8 in which the message is the Handover Acknowledgement (HACK) message in the case of FMIP.

10. A method as claimed in claim 1 in which an acceptable nCoA and additional information is carried in a message between the first communications node and the mobile node that is used to trigger the tunnelling of packets between the first and second communication nodes.

11. A method as claimed in claim 10 in which the message is the Fast Binding Acknowledgement (FBACK) message in the case of FMIP.

12. A method as claimed in claim 1 in which the accompanying information includes a list of secondary CGAnCoAs, one of which is chosen if the proposed CGAnCoA is not acceptable.

13. A method as claimed in claim 12 in which the list is generated by the mobile node.

14. A method as claimed in claim 13 in which the list is included in a message used by the MN to inform the first communications node of its impending intention to change to the second communications node.

15. A method as claimed in claim 14 in which the message is the Fast Binding Update (FBU) message in the case of FMIP.

16. A method as claimed in claim 12 in which the list is included in a message between the first and second communications nodes indicating the readiness of the MN to change communications nodes.

17. A method as claimed in claim 16 in which the message is the Handover Initiation (HI) message in the case of FMIP.

18. A method as claimed in claim 12 in which a message between the first and second communications nodes indicating the readiness of the second communications node to receive the MN includes an index identifying one of the list of proposed addresses that is acceptable.

19. A method as claimed in claim 18 in which the message is the Handover Acknowledgement (HACK) message in the case of FMIP.

20. A method as claimed in claim 12 in which a message between the first communications node and the mobile node that is used to trigger the tunnelling of packets between the first and second communication nodes includes an index identifying one of the proposal addresses that is acceptable.

21. A method as claimed in claim 20 in which the message is the Fast Binding Acknowledgement (FBACK) message in the case of FMIP.

22. A method as claimed in claim 1 in which the test for acceptability of an address is duplicate address detection.
